(19) United States
(12) Patent Application Publication
(10) Pub. No.: US 2016/0271583 A1
(43) Pub. Date: Sep. 22, 2016

(54) SUPERABSORBENT COMPOSITIONS FOR SOLIDIFYING INDUSTRIAL FLUID WASTES

(71) Applicant: Infield Products Inc., Calgary (CA)

(72) Inventors: Ferron Ernest KENMORE, Medicine Hat (CA); Ferron Tyrel KENMORE, Medicine Hat (CA)

(73) Assignee: Infield Products Inc., Calgary (CA)

(21) Appl. No.: 15/069,638

(22) Filed: Mar. 14, 2016

Related U.S. Application Data
(60) Provisional application No. 62/133,820, filed on Mar. 16, 2015.
(60) Provisional application No. 62/171,310, filed on Jun. 5, 2015.
(60) Provisional application No. 62/286,685, filed on Jan. 25, 2016.

(51) Int. Cl. B01J 20/26; B01J 20/28; C02F 11/00; B01J 20/24

(52) U.S. Cl. CPC B01J 20/26; B01J 20/24; B01J 20/28016; C02F 11/008; C02F 2103/10

(57) ABSTRACT

The invention provides a composition for solidification of a viscous fluid waste material. The composition comprises a mixture of: (i) a post-anaerobic composted solids material having a particle size in a range of about 60 mesh to 120 mesh; and (ii) a granular superabsorbent polymer material having a particle size in a range of about 80 mesh to about 120 mesh. The ratio of the composted solids material to superabsorbent polymer material in the composition is between about 80:20 wt/wt and about 95:5 wt/wt. The moisture content of the composition is between about 12.5% and about 17.5%.

### RELATED APPLICATIONS

This application claims priority under 35 U.S.C. §119(e) to U.S. Provisional Patent Application No. 62/133,820, filed Mar. 16, 2015, 62/171,310, filed Jun. 5, 2015, and 62/286,685, filed Jan. 25, 2016, which applications are incorporated herein by reference.

### FIELD OF THE DISCLOSURE

This disclosure relates to disposal of fluid waste materials. More particularly, this disclosure relates to superabsorbent compositions for absorbing, gelling, and solidifying fluid wastes to facilitate the ease and efficiency for high-volume handling, transport, and disposal.

### BACKGROUND OF THE DISCLOSURE

Many industrial processes generate exceedingly high volumes of fluid waste streams comprising water, various organic and inorganic compounds in solution, heavy metals, small and very small molecular weight particulates that remain suspended throughout fluid waste streams. Examples of such industrial processes include ore extraction from geological surface deposits and from subterranean deposits, ore processing and refining, extraction of crude oil and bitumen from subterranean reservoirs using pressurized steam and/or hot water, drilling into and fracking geological formations with drilling fluids and fracking fluids, recovery of and refining of bitumen from oil sand deposits, and the like. The fluid waste streams from such industrial processes are commonly diverted into large holding ponds for extended periods of time so that particulates will settle out of the waste fluids. However, many fluid wastes held for extended periods of time in settling ponds develop increasing concentrations of suspended particulates on a per litre basis as the depth of the ponds increases from the pond surfaces to the sediment surfaces at the bottoms of the ponds. Accordingly, the viscosities of such fluid wastes gradually increase from very low at the pond surfaces to very high and thickened toward the bottoms of the ponds. It is common practice to recover the low viscosity upper regions of fluid waste ponds for water treatment and recycling back into the industrial process. However, a major problem is that the higher viscosity fluid wastes are incompatible with most common industrial waste water treatment processes, and therefore remain in the settling ponds in their high viscosity states. Due to environmental regulatory restriction on disposal of such high viscosity industrial fluid wastes, such fluid wastes remain for extended periods of time in their settling ponds which in turn, significantly increase in volume and surface area requirements. Common approaches for safe removal of such high viscosity fluid wastes include incorporation of gelling agents exemplified by super absorbent polymers or alternatively, by solidifying agents exemplified by cement-type binders and clays. However, a problem with gelling agents is that the resulting mixtures with high viscosity fluid wastes are structurally unstable under pressure, and they cannot be compacted into a firm and stable material. The problem with solidifying agents mixed with high viscosity fluid wastes is that they tend to form very high density hardened materials that are difficult to handle in bulk and because of their weight, very expensive to transport.

Other examples of high-volume industrial outputs of fluid waste streams include animal processing and rendering facilities, food and beverage production facilities, and chemicals manufacturing and processing. Such types of industries as well as refineries, commonly rely on dedicated waste stream decontamination, treatment, and purification treatment plants for the purposes of recovering and recycling the fluid waste streams back into the industrial processes for purposes exemplified by cooling and washing. Such treatment facilities however, generate considerable volumes of slurries and/or semi-solids wherein are concentrated organic and inorganic compounds that were separated and recovered from the fluid waste streams. Such slurries and semi-solids require fastidious disposal strategies and are often regulated by numerous municipal, regional, and federal government agencies.

### SUMMARY OF THE DISCLOSURE

The exemplary embodiments of the present disclosure relates to compositions for structurally stable solidification of viscous fluid wastes, the use of the compositions, and to methods for the use of the compositions.

According to one exemplary embodiment, a suitable composition comprises a mixture of: (i) a post-anaerobic composted solids material having a particle size in a range of about 60 mesh to 120 mesh; and (ii) a granular superabsorbent polymer material having a particle size in a range of about 80 mesh to about 120 mesh. The ratio of the composted solids material to superabsorbent polymer material in the composition is between 80:20 wt/wt and 90:10 wt/wt. The moisture content of the composition is between 12.5% and 17.5%.

According to one aspect, the composted solids material is derived from anaerobic digestion of a large volume dairy cattle waste stream. According to another aspect, the composted solids material is derived from anaerobic digestion of a cattle waste stream from a large volume feedlot operation.

Another exemplary embodiment pertains to a mixture comprising (i) a sawdust material having a particle size in a range of about 40 mesh to 120 mesh; and (ii) a granular superabsorbent polymer material having a particle size in a range of about 80 mesh to about 120 mesh. The ratio of the composted solids material to superabsorbent polymer material in the composition is between 80:20 wt/wt and 90:10 wt/wt. The moisture content of the composition is between 12.5% and 17.5%.

Another exemplary embodiment relates to use of the compositions of the present disclosure to solidify viscous fluid waste materials into structurally stables solids materials by commingling the viscous fluid waste materials with the compositions at a rate of about 2% to 10% of the composition by weight.

### DETAILED DESCRIPTION

The exemplary embodiments disclosed herein relate to compositions for solidifying viscous fluid waste materials to facilitate their cartage to and disposal in off-site waste disposal sites. Some exemplary embodiments relate to use and methods of use of the compositions disclosed herein.

It has been proposed that superabsorbent polymers are useful for gelling and stabilizing viscous industrial fluid wastes comprising high levels of suspended particulate matter. Such viscous industrial fluid wastes are exemplified by fluid waste streams produced during extraction, processing and refining of minerals from mining operations, by extraction, processing and refining of crude oil and bitumen from subterranean reservoirs or from oil sand deposits, by fluid waste streams produced during animal or poultry or fish processing and rendering facilities, by fluid waste streams produced by food and beverage production facilities, by fluid waste streams produced during chemicals manufacturing and processing, and other types of industrial process that rely on water for extraction and/or processing and/or refining and/or purification processes. However, a problem encountered in use of superabsorbent polymers for gelling and stabilizing viscous industrial fluid wastes comprising high levels of suspended particulate matter, is that the resulting gelled fluid waste material is structurally unstable and cannot be sufficiently compacted to support the weight of compacting equipment exemplified by bulldozers, self-propelled compactors, front-end loaders and the like. Furthermore, the structural instability of gelled fluid waste material prevents increasing the depth or height of such material in disposal site.

One solution proposed for improving the structural instability of gelled viscous fluid waste material was to combine superabsorbent polymers with suitable bulking materials for gelling, stabilizing and solidifying viscous fluid waste streams. For example, pulverized wood pellets, sawdust, peats, and the like, have been proposed as suitable bulking agents. However, it has been found that the viscous fluid waste streams solidified with combinations of superabsorbent polymers and bulking agents form unstable frangible solids that are not amenable to compaction.

We have surprisingly discovered that that solids produced during anaerobic digestion of animal wastes produced by large herds of dairy cattle or alternatively, by cattle held in large-capacity feedlots for production of meat, are particularly suitable bulking agents for combining with superabsorbent polymers into compositions useful for the gelling and solidification of viscous industrial fluid wastes into structurally stable solids that can be compacted sufficiently to support the weight of compaction equipment and to retain the compacted structural integrity for extended periods of time. Such solids recovered post-anaerobic digestion of dairy cattle wastes and/or feedlot cattle wastes are referred to herein after as “composted solids”.

Suitable solidifying agents for use in the compositions and methods of the present disclosure are exemplified by superabsorbent polymer powders and gels that are able to absorb up to five hundred times their weight in water. Suitable superabsorbent polymer powders and gels are exemplified by sodium polyacrylates, polyacrylamide copolymers, ethylene maleic anhydride copolymers, cross-linked carboxymethylcellulose, polyvinyl alcohol copolymers, cross-linked polyethylene oxide, starch-grafted copolymers of polyacrylonitrile, the like, and combinations thereof. Sodium polyacrylate (CAS #9033-04-7) is particularly suitable for use as a solidifying agent in the methods and systems of the present disclosure. Another particularly suitable superabsorbent polymer is exemplified by WASTE LOCK® 770 (WASTE LOCK is a registered trademark of M2 Polymer Technologies Inc., West Dundee, Ill., USA).

The particle sizes of the superabsorbent polymer powders and gels that are useful in the methods and systems of the present disclosure are generally heterogenous mixtures of particles ranging in size from about 70 mesh (0.21 mm) to about 200 mesh (0.074 mm). If so desired, a more homogenous mixture of superabsorbent polymer particle sizes ranging in size from about 80 mesh (0.177 mm) to about 120 mesh (0.125 mm) may be provided. A particularly suitable superabsorbent polymer particle size in the range of about 80 mesh (0.163 mm) to about 100 mesh (0.1.49 mm). It is within the scope of the present disclosure to grind a commercially available superabsorbent polymer comprising a heterogenous mixture of granules ranging in size from about 20 mesh (0.841 mm) to about 200 mesh (0.074 mm) and then separate out and recover for use in the compositions disclosed herein, a fraction with particle sizes ranging in size from ranging 80 mesh (0.177 mm) to about 100 mesh (0.149 mm).

The composted solids may comprise a heterogenous mixture of particle sizes preferably have a mesh size of 40 (0.420 mm) or smaller, for example 50 mesh (0.297 mm), 60 mesh (0.25 mm), 80 mesh (0.177 mm), 100 mesh (0.149 mm). Particularly suitable are composted solids with particle sizes in the range of about 80 mesh (0.711 mm) to about 100 mesh (0.149 mm). It is within the scope of the present disclosure to mill or grind a heterogenous mixture of composted solids to produce a mixture having particle sizes of 80 mesh (0.177 mm) and smaller.

The exemplary compositions disclosed herein comprise a mixture of composted solids and superabsorbent polymer granules at a ratio of about 80:20 wt/wt, 82.5:17.5 wt/wt, 85:15 wt/wt, wt/wt, 87.5:12.5 wt/wt, 90:10 wt/wt, and therebetween. Particularly suitable is a mixture comprising 85% composted solids and 15% superabsorbent polymer granules. The water content of the composted solids/superabsorbent polymer granular mixture is about 12.5%, 15%, 17.5%, 20%. A particularly suitable moisture content for the present composition is in the range of about 15% to about 17.5%.

Some exemplary compositions disclosed herein be prepared by blending together a selected amount of composted solids and superabsorbent polymer granules from the ranges disclosed herein using commercial-scale blending equipment exemplified by ribbon blenders, tumble blenders, paddle blenders, cone blenders and the like. If it is necessary to add moisture during blending to adjust the moisture to a target range of about 15% to about 17.5%, then it is preferable to add water amended with a surfactant. Suitable surfactants are exemplified by phosphate ester surfactants such as AQUALON®, DEXTROL®, STRODEX® and the like (AQUALON, DEXTROL, and STRODEX are registered trademarks of Hercules Inc., Wilmington, Del., USA). After blending has been completed, the compositions may be dispensed into 50-lb bags, 1-ton bulk bags, or alternatively, stored and shipped in bulk volumes. We have surprisingly discovered that the exemplary compositions disclosed herein comprising a mixture of composted solids and superabsorbent polymer granules wherein: (i) the composted solids are solids recovered post-anaerobic digestion of dairy cattle wastes and/or feedlot cattle wastes, and (ii) the superabsorbent granules comprise a mixture of granules having particle sizes from a range of about 80 mesh to about 100 mesh, are able to absorb up to two hundred times its weight in viscous fluid wastes. Accordingly, a viscous fluid waste can be solidified by commingling with or intermixing with 1%, 2%, 3%, 4%, or 5% of the present composition by weight.

It is also within the scope of the present disclosure to blend together composted solids with superabsorbent polymer granules as they are being commingled with the viscous fluid wastes through the dispensing tee apparatus wherein the viscous fluid wastes are conveyed through the first conduit and dispensed through the first orifice, while the composted solids and the superabsorbent polymer granules are separately dispensed into the inlet of the second conduit and conveyed therethrough under positive air pressure to the second orifice. For example, the composted solids may be dispensed into a first hopper for conveyance at a first selected rate to the inlet of the second conduit. The superabsorbent polymer granules may be dispensed into a second hopper for conveyance at a second selected rate to the inlet of the second conduit. Suitable ratios of dispensing composted solids and superabsorbent polymer granules into the inlet end of the second conduit are about 80:20 wt/wt, 82.5:17.5 wt/wt, 85:15 wt/wt, wt/wt, 87.5:12.5 wt/wt, 90:10 wt/wt, and therebetween. Particularly suitable is a mixture comprising 85% composted solids and 15% superabsorbent polymer granules. It should be noted that a viscous fluid waste can be solidified by commingling with or intermixing with 1%, 2%, 3%, 4%, 5%, 7.5%, 10% and therebetween by weight of the present composted solids/superabsorbent polymer granules during dispensing from the dispensing tee apparatus.

Another exemplary embodiment of the present disclosure pertains to compositions comprising mixtures of sawdust particles and superabsorbent polymer granules, for solidifying viscous fluid waste materials to facilitate their cartage to and disposal in off-site waste disposal sites. Suitable sawdust particles are exemplified by bulk sawdusts produced by sawmills during processing of harvested logs into lumber. Suitable sawdust may comprise a heterogenous mixture of particle sizes, preferably having a mesh size of 40 (0.420 mm) or smaller, for example 50 mesh (0.297 mm), 60 mesh (0.25 mm), 80 mesh (0.177 mm), 100 mesh (0.149 mm). Particularly suitable are sawdust particle sizes in the range of about 80 mesh (0.711 mm) to about 100 mesh (0.149 mm). Also suitable are pelletized sawdust particles that can be milled or ground into a heterogenous mixture of sawdust particles having particle sizes of 80 mesh (0.177 mm) and smaller. Suitable sawdust pellets are exemplified by La-Crete Wood Pellets available from La Crete Sawmills Ltd. (Hwy 697 South, La Crete, AB, CA, T0H 2H0).

Some exemplary compositions disclosed herein may comprise mixtures of sawdust particles and superabsorbent polymer granules at a ratio of about 80:20 wt/wt, 82.5:17.5 wt/wt, 85:15 wt/wt, wt/wt, 87.5:12.5 wt/wt, 90:10 wt/wt, 95:5 wt/wt, and therebetween. Particularly suitable is a mixture comprising 85% sawdust and 15% superabsorbent polymer granules. The water content of the sawdust/superabsorbent polymer granular mixture is about 12.5%, 15%, 17.5%, 20%. A particularly suitable moisture content for the present composition is in the range of about 15% to about 17.5%.

It is also within the scope of the present disclosure to blend together pelletized sawdust with superabsorbent polymer granules as they are being commingled with the viscous fluid wastes through the dispensing tee apparatus wherein the viscous fluid wastes are conveyed through the first conduit and dispensed through the first orifice, while the pelletized sawdust pellets and the superabsorbent polymer granules are separately dispensed into the inlet of the second conduit and conveyed therethrough under positive air pressure to the second orifice. For example, the sawdust pellets may be dispensed into a first hopper for conveyance at a first selected rate to the inlet of the second conduit. The superabsorbent polymer granules may be dispensed into a second hopper for conveyance at a second selected rate to the inlet of the second conduit. Suitable ratios of dispensing pelletized sawdust and superabsorbent polymer granules into the inlet end of the second conduit are about 80:20 wt/wt, 82.5:17.5 wt/wt, 85:15 wt/wt, wt/wt, 87.5:12.5 wt/wt, 90:10 wt/wt, and therebetween. Particularly suitable is a mixture comprising 85% sawdust pellets and 15% superabsorbent polymer granules. The air pressurized conveyance through the second conduit causes disintegration of the sawdust pellets into sawdust particles that are concurrently blended with the superabsorbent polymer granules as the mixture is conveyed to the second orifice. It should be noted that a viscous fluid waste can be solidified by commingling with or intermixing with 1%, 2%, 3%, 4%, 5%, 7.5%, 10% and therebetween by weight of the present sawdust/superabsorbent polymer granules during dispensing from the dispensing tee apparatus.

Another exemplary embodiment of the present disclosure pertains to compositions comprising mixtures of fly ash and superabsorbent polymer granules, for solidifying viscous fluid waste materials to facilitate their cartage to and disposal in off-site waste disposal sites. Fly ash is one of the residues generated by combustion of coal in industrial furnaces exemplified by those used for generation of electricity, production of steel, metal refineries and the like. Fly ash is composed of fine particles that are driven out of industrial furnaces with the flue gases. Fly ash is generally captured by particle filtration equipment exemplified by electrostatic precipitators before the flue gases reach the chimneys of coal-fired power plants. In North America, about 43% of captured fly ash is recycled, primarily for use as a “pozzolan” (i.e., a material that reacts with calcium hydroxide and water to form a cementitious materials) for production of hydraulic cements and hydraulic plasters or as a partial or full replacement for Portland cement in concrete production. Fly ash primarily comprises SiO₂, Al₂O₃, Fe₂O₃, and CaO, and the concentrations of these minerals vary with the type of coal that is combusted, i.e., bituminous coal, sub-bituminous coal, lignite coal, as exemplified in Table 1.

Generally, there are two types of fly ash defined by ASTM C618, i.e., Class F fly ash and Class C fly ash. Class F fly ash is produced by the burning of harder, older anthracite and bituminous coal and my require addition of a cementing agent exemplified by Portland cement, quicklime, hydrated lime, sodium silicate, and the like, to produce cementitious compounds. Class C fly ash is produced from the burning of younger lignite or sub-bituminous coal, in addition to having pozzolanic properties, also has some self-cementing properties. In the presence of water, Class C fly ash hardens and gets stronger over time. Class C fly ash generally contains more than 20% lime (CaO). Unlike Class F, self-cementing Class C fly ash does not require an activator.

TABLE 1

| Component | Bituminous | Sub-bituminous | Lignite |
|---|---|---|---|
| SiO₂ (%) | 20-60 | 40-60 | 15-45 |
| Al₂O₃ (%) | 5-35 | 20-30 | 20-25 |
| Fe₂O₃ (%) | 10-40 | 4-10 | 4-15 |
| CaO (%) | 1-12 | 5-30 | 15-40 |

We have surprisingly discovered that fly ashes are suitable materials to blend together with superabsorbent polymer granules to produce additional exemplary compositions according to this disclosure. Suitable ratios for blending fly ash with superabsorbent granules are ratios of about 80:20 wt/wt (fly ash:superabsorbent granules), 82.5:17.5 wt/wt, 85:15 wt/wt, wt/wt, 87.5:12.5 wt/wt, 90:10 wt/wt, and therebetween. Particularly suitable is a mixture comprising 85% fly ash and 15% superabsorbent polymer granules. In cases where the exemplary compositions comprise Class F fly ash and superabsorbent granules, it may be necessary add to these mixtures 5%, 7.5%, 10%, 12.5%, 15%, 17.5%, 20% and therebetween one of Portland cement, quicklime, hydrated lime, sodium silicate, and the like. It should be noted that a viscous fluid waste can be solidified by commingling with or intermixing with 1%, 2%, 3%, 4%, 5%, 7.5%, 10% and therebetween by weight of the present fly ash/superabsorbent polymer granules during dispensing from the dispensing tee apparatus.

It is also within the scope of the present disclosure to blend together fly ash with superabsorbent polymer granules as they are being commingled with the viscous fluid wastes through the dispensing tee apparatus wherein the viscous fluid wastes are conveyed through the first conduit and dispensed through the first orifice, while the fly ash and the superabsorbent polymer granules are separately dispensed into the inlet of the second conduit and conveyed therethrough under positive air pressure to the second orifice. For example, the fly ash may be dispensed into a first hopper for conveyance at a first selected rate to the inlet of the second conduit. The superabsorbent polymer granules may be dispensed into a second hopper for conveyance at a second selected rate to the inlet of the second conduit. Suitable ratios of dispensing fly ash and superabsorbent polymer granules into the inlet end of the second conduit are about 80:20 wt/wt, 82.5:17.5 wt/wt, 85:15 wt/wt, wt/wt, 87.5:12.5 wt/wt, 90:10 wt/wt, and therebetween. Particularly suitable is a mixture comprising 85% fly ash and 15% superabsorbent polymer granules. It should be noted that a viscous fluid waste can be solidified by commingling with or intermixing with 1%, 2%, 3%, 4%, 5%, 7.5%, 10% and therebetween by weight of the present composted solids/superabsorbent polymer granules during dispensing from the dispensing tee apparatus.

It is also within the scope of the present disclosure to blend together composted solids with sawdust particles, or alternatively with sawdust pellets, to form a composted solids/sawdust mixture that is then blended together with superabsorbent polymer granules. Suitable mixtures of composted solids and sawdust include ratios of about 10:90 wt/wt, 20:80 wt/w/, 30:70 wt/wt, 40:60 wt/wt, 50:50 wt/wt, 60:40 wt/wt, 70:30 wt/wt, 80:20 wt/wt, 90:10 wt/wt, and therebetween. Some exemplary compositions disclosed herein may comprise mixtures of (i) composted solids and sawdust particles, and (ii) superabsorbent polymer granules at a ratio of about 80:20 wt/wt, 82.5:17.5 wt/wt, 85:15 wt/wt, wt/wt, 87.5:12.5 wt/wt, 90:10 wt/wt, 95:5 wt/wt, and therebetween. Particularly suitable is a mixture comprising 85% composted solids/sawdust and 15% superabsorbent polymer granules. The water content of the composted solids/sawdust/superabsorbent polymer granular mixture is about 12.5%, 15%, 17.5%, 20%. A particularly suitable moisture content for the present composition is in the range of about 15% to about 17.5%.

It is also within the scope of the present disclosure to blend together a Class F fly ash or a Class C fly ash with sawdust particles, or alternatively with sawdust pellets, to form a fly ash/sawdust mixture that is then blended together with superabsorbent polymer granules. Suitable mixtures of fly ash and sawdust include ratios of about 10:90 wt/wt, 20:80 wt/wt, 30:70 wt/wt, 40:60 wt/wt, 50:50 wt/wt, 60:40 wt/wt, 70:30 wt/wt, 80:20 wt/wt, 90:10 wt/wt, and therebetween. Some exemplary compositions disclosed herein may comprise mixtures of (i) fly ash and sawdust particles, and (ii) superabsorbent polymer granules at a ratio of about 80:20 wt/wt, 82.5:17.5 wt/wt, 85:15 wt/wt, wt/wt, 87.5:12.5 wt/wt, 90:10 wt/wt, 95:5 wt/wt, and therebetween. Particularly suitable is a mixture comprising 85% fly ash/sawdust and 15% superabsorbent polymer granules. The water content of the fly ash/sawdust/superabsorbent polymer granular mixture is about 12.5%, 15%, 17.5%, 20%. A particularly suitable moisture content for the present composition is in the range of about 15% to about 17.5%.

It is also within the scope of the present disclosure to blend together: (i) a composted solids material, with (ii) Class F fly ash or a Class C fly ash, and (iii) with sawdust particles, or alternatively with sawdust pellets, to form a composted solids/fly ash/sawdust mixture that is then blended together with superabsorbent polymer granules. Suitable mixtures of fly ash and sawdust include ratios of about 10:10:80 wt/wt/wt, 20:10:70 wt/wt/wt, 30:10:60 wt/wt/wt, 40:10:50 wt/wt/wt, 50:10:40 wt/wt/wt, 60:10:30 wt/wt/wt, 70:10:20 wt/wt/wt, 80:10:10 wt/wt/wt, 10:20:70 wt/wt/wt, 10:30:60 wt/wt/wt, 10:40:50 wt/wt/wt, 10:50:40 wt/wt/wt, 10:60:30 wt/wt/wt, 10:70:20 wt/wt/wt, 10:80:10 wt/wt/wt, and therebetween.

Some exemplary compositions disclosed herein may comprise mixtures of (i) composted solids/fly ash/sawdust particles, and (ii) superabsorbent polymer granules at a ratio of about 80:20 wt/wt, 82.5:17.5 wt/wt, 85:15 wt/wt, wt/wt, 87.5:12.5 wt/wt, 90:10 wt/wt, 95:5 wt/wt, and therebetween. Particularly suitable is a mixture comprising 85% composted solids/fly ash/sawdust and 15% superabsorbent polymer granules. The water content of the composted solids/fly ash/sawdust/superabsorbent polymer granular mixture is about 12.5%, 15%, 17.5%, 20%. A particularly suitable moisture content for the present composition is in the range of about 15% to about 17.5%.

The compositions disclosed herein can be used for solidification of viscous fluid wastes by conveying the viscous fluid wastes from a storage container a transportable bulk container through a first conduit terminating with a dispensing tee apparatus having a first orifice in communication with the first conduit, and concurrently conveying the present composition from a bulk storage container through a second conduit in communication with a second orifice in the dispensing tee apparatus, whereby the viscous fluid wastes and the composition are commingled as they are dispensed from the tee apparatus into the transportable bulk container. A suitable commingling rate for the compositions with the viscous fluid wastes is from the range of about 2% to about 10% by weight. A suitable dispensing tee apparatus and related conveyance system for conveying and commingling viscous fluid wastes and a gelling/solidifying composition is disclosed in Canadian Patent No. 2,787,745. Alternatively, the present composition can be dispensed into a viscous fluid waste at a rate of about 2% to about 15% by weight while the fluid waste is being conveyed by a screw conveyor wherein the fluid waste will solidify and subsequently be dispensed as a discontinuous solids material into piles for storage, or alternatively, into a transportable bulk container. Another way of using the present compositions for solidifying viscous fluid wastes, is to add a predetermined amount of the composition to a known volume of viscous fluid waste being held in a storage container, by dispensing the composition across the surface of the fluid waste. The composition will settle into and throughout the viscous fluid waste and cause solidification of the fluid waste during the settling process. Alternatively, the composition can be mixed into the viscous fluid wastes by conventional equipment exemplified by frontend loaders, backhoes, excavators, and the like, to facilitate solidification. The solidified fluid waste material can then be removed from the storage container with conventional equipment exemplified by frontend loaders, backhoes, excavators, and the like.

The following examples are provided to enable a better understanding of the disclosure described herein.

### EXAMPLES

### Example 1

A bulk quantity of suitable composted solids was sourced from the output of an agricultural biogas digester used for anaerobic digestion of wastes produced by lactating dairy cattle. Three samples of the composted solids were analyzed for their chemical composition and their physical properties, prior to preparation of an exemplary composition of the present disclosure. The composted solids analyses data are shown in Table 2.

TABLE 2

| Parameter | Detected Level | |
|---|---|---|
| Physical descriptions | | |
| pH | 8.4 | |
| Electrical conductivity | 25.8 dSm@25° C. | |
| Sodium absorption ratio | 21.7 | |
| Exchangeable sodium % | 23.0% | |
| Saturation % | 67.0% | |
| Soluble cations | | |
| Calcium | 97 | mg/Kg |
| Magnesium | 132 | mg/Kg |
| Sodium | 1140 | mg/Kg |
| Potassium | 4900 | mg/Kg |
| Calcium (meq) | 7.26 | meq/L |
| Magnesium (meq) | 16.2 | meq/L |
| Sodium (meq) | 74.2 | meq/L |
| Potassium (meq) | 187.0 | meq/L |
| Calcium (conc) | 146 | mg/L |
| Magnesium (conc) | 197 | mg/L |
| Sodium (conc) | 1710 | mg/L |
| Potassium (conc) | 7310 | mg/L |
| Available nutrients | | |
| Nitrate—N | 321 | mg/Kg |
| Phosphate—P | 607 | mg/Kg |
| Potassium—K | 8260 | mg/Kg |
| Sulfate—S | 522 | mg/Kg |
| Soluble anions | | |
| Sulfate | 2470 | mg/Kg |
| Chloride | 2950 | mg/Kg |
| Sulfate (meq) | 76.9 | meq/L |
| Chloride (meq) | 124.0 | meq/L |
| Sulfate (conc) | 3690 | mg/L |
| Chloride (conc) | 4400 | mg/L |

Those skilled in these arts will realize that the compositions and methods of the present disclosure are suitable for recovery and disposal of fluid wastes from storm drains and sewers, from holding facilities storing fluid waste streams generated by industrial processing operations or by food processing operations, from tailing water pond reservoirs receiving and storing fluid wastes from mining operations or from bitumen processing. The methods, systems and apparatus of the present disclosure are also suitable for recovery and disposal of sediments from fluid/solid interfaces at the bottoms of tailing water pond reservoirs receiving and storing fluid wastes from mining operations or from bitumen processing.

1. A composition for solidification of a viscous fluid waste material, the composition comprising a mixture of:
one of (i) a post-anaerobic composted solids material having a particle size in a range of about 60 mesh to 120 mesh, (ii) a sawdust material having a particle size in a range of about 60 mesh to 120 mesh, and (iii) a class F fly ash material or a class C fly ash material; and
a granular superabsorbent polymer material having a particle size in a range of about 80 mesh to about 120 mesh;
wherein the ratio of the composted solids material or the sawdust material or the fly ash material to the superabsorbent polymer material is between 80:20 wt/wt and 90:10 wt/wt, and the moisture content of the composition is between 12.5% and 17.5%.

2. (canceled)

3. (canceled)

4. A composition according to claim 1, wherein:
(i) the ratio of the composted solids material to the sawdust material is between 10:90 wt/wt and 90:10 wt/wt; and
(ii) the ratio of the composted solids material and the sawdust material to superabsorbent polymer material is between 80:20 wt/wt and 90:10 wt/wt, and the moisture content of the composition is between 12.5% and 17.5%.

5. A composition according to claim 1, wherein:
(i) the ratio of the composted solids material to the sawdust material to the fly ash material is between 10:10:80 wt/wt/wt and 80:10:10 wt/wt; and
(ii) the ratio of the composted solids material, the sawdust material and the fly ash material to superabsorbent polymer material is between 80:20 wt/wt and 90:10 wt/wt, and the moisture content of the composition is between 12.5% and 17.5%.

6. A composition according to claim 1, wherein:
(i) the ratio of the composted solids material to the fly ash material is between 10:90 wt/wt and 90:10 wt/wt; and
(ii) the ratio of the composted solids material and the fly ash material to superabsorbent polymer material is between 80:20 wt/wt and 90:10 wt/wt, and the moisture content of the composition is between 12.5% and 17.5%.

7. A composition according to claim 1, wherein:
(i) the ratio of the sawdust material to the fly ash material is between 10:90 wt/wt and 90:10 wt/wt; and
(ii) the ratio of the sawdust material and the fly ash material to superabsorbent polymer material is between 80:20 wt/wt and 90:10 wt/wt, and the moisture content of the composition is between 12.5% and 17.5%.

8. (canceled)

9. A method for solidifying a viscous fluid waste material, the method comprising:
commingling the viscous fluid waste material with the composition of claim 1, wherein the composition is added to the viscous fluid waste material at a rate of about 1.5% to about 15% by weight.

10. (canceled)

11. The method according to claim 9, comprising the steps of:
conveying the viscous fluid waste material within a first conduit to a first orifice in a dispensing tee apparatus;
conveying the composition within a second conduit to a second orifice; and
concurrently dispensing the viscous fluid waste material and the composition from the dispensing tee apparatus, wherein the ratio of the viscous fluid waste material to the composition is between about 1.5% to about 15% by weight.

12. A method for solidifying a viscous fluid waste material, the method comprising:
conveying the viscous fluid waste material within a first conduit to a first orifice in a dispensing tee apparatus;
conveying a blend of sawdust pellets and a granular superabsorbent polymer material within a second conduit to a second orifice in the dispensing tee apparatus, said blend comprising a ratio of the sawdust to the superabsorbent polymer material between 80:20 wt/wt and 90:10 wt/wt; and
concurrently dispensing the viscous fluid waste material and the blended sawdust and superabsorbent polymer material from the dispensing tee apparatus, wherein the ratio of the viscous fluid waste material to the blend of sawdust and superabsorbent polymer material is between about 1.5% to about 15% by weight.
